(19) United States
(12) Patent Application Publication
(10) Pub. No.: US 2016/0242073 A1
(43) Pub. Date: Aug. 18, 2016

(54) METHOD AND APPARATUS FOR GENERATING A PHY HEADER FIELD

(71) Applicant: MARVELL WORLD TRADE LTD., St. Michael (BB)

(72) Inventors: Hongyuan Zhang, Fremont, CA (US); Sudhir Srinivasa, Campbell, CA (US)

(21) Appl. No.: 15/138,193

(22) Filed: Apr. 25, 2016

Related U.S. Application Data
(62) Division of application No. 14/446,124, filed on Jul. 29, 2014.
(60) Provisional application No. 61/859,483, filed on Jul. 29, 2013.

(51) Int. Cl. H04W 28/06; H04W 72/04; H04L 27/26

(52) U.S. Cl. CPC H04W 28/065; H04L 27/2602; H04W 72/0453; H04W 84/12

(57) ABSTRACT

In a method of generating a field of a physical layer (PHY) header of a data unit, bits to be included in the field are generated and the bits are duplicated to generate duplicated bits. First modulation data is generated based on the duplicated bits. The first modulation data corresponds to a first set of orthogonal frequency domain multiplexing (OFDM) sub-carriers corresponding to a first frequency band. Second modulation data is generated using the first modulation data. The second modulation data corresponds to a second set of OFDM sub-carriers corresponding to a second frequency band. One or more signals i) that span the first frequency band and the second frequency band and ii) that correspond to field of the PHY header are generated. Generating the one or more signals includes performing a frequency domain to time domain conversion based on the first modulation data and the second modulation data.

### CROSS-REFERENCES TO RELATED APPLICATIONS

This application is a divisional of U.S. patent application Ser. No. 14/446,124, filed on Jul. 29, 2014, entitled “Method and Apparatus for Generating a PHY Header Field,” which claims the benefit of U.S. Provisional Patent Application No. 61/859,483, entitled “VHTSIGB for 160 MHz and 80+80 MHz,” filed on Jul. 29, 2013. The applications referenced above are hereby incorporated by reference herein in their entireties.

### FIELD OF THE DISCLOSURE

The present disclosure relates generally to communication networks and, more particularly, to physical layer (PHY) communication protocols used in wireless local area networks (WLAN).

### BACKGROUND

Development of WLAN standards such as the Institute for Electrical and Electronics Engineers (IEEE) 802.11a, 802.11b, 802.11g, and 802.11n Standards has improved single-user peak data throughput. For example, the IEEE 802.11b Standard specifies a single-user peak throughput of 11 megabits per second (Mbps), the IEEE 802.11a and 802.11g Standards specify a single-user peak throughput of 54 Mbps, the IEEE 802.11n Standard specifies a single-user peak throughput of 600 Mbps, and the IEEE 802.11ac Standard specifies a single-user peak throughput in the gigabits per second (Gbps) range. The IEEE 802.11ac Standard permits use of channels that have a bandwidth of 160 MHz.

### SUMMARY

In an embodiment, a method of generating a field of a physical layer (PHY) header of a data unit includes generating bits to be included in the field, and duplicating the bits to generate duplicated bits; The method also includes generating first modulation data based on the duplicated bits, the first modulation data corresponding to a first set of orthogonal frequency domain multiplexing (OFDM) sub-carriers corresponding to a first frequency band, and generating second modulation data using the first modulation data, the second modulation data corresponding to a second set of OFDM sub-carriers corresponding to a second frequency band. The method additionally includes generating one or more signals i) that span the first frequency band and the second frequency band and ii) that correspond to field of the PHY header, wherein generating the one or more signals includes performing a frequency domain to time domain conversion based on the first modulation data and the second modulation data.

In another embodiment, an apparatus comprises a network interface having a physical layer (PHY) processing unit configured to generate bits to be included in a field of a PHY header, and duplicate the bits to generate duplicated bits. The PHY processing unit is further configured to generate first modulation data based on the duplicated bits, the first modulation data corresponding to a first set of orthogonal frequency domain multiplexing (OFDM) sub-carriers corresponding to a first frequency band, an generate second modulation data using the first modulation data, the second modulation data corresponding to a second set of OFDM sub-carriers corresponding to a second frequency band. The network interface is configured to generate one or more signals i) that span the first frequency band and the second frequency band and ii) that correspond to field of the PHY header, including performing a frequency domain to time domain conversion based on the first modulation data and the second modulation data.

In yet another embodiment, a method of generating a field of a physical layer (PHY) header of a data unit includes generating bits to be included in the field, duplicating the bits to generate duplicated bits, and parsing the duplicated bits into a plurality of segments. The method also includes for each segment, interleaving duplicated bits within the segment without interleaving duplicated bits from other segments. The method additionally includes after interleaving duplicated bits, generating modulation data based on the duplicated bits, the modulation data corresponding to a plurality of orthogonal frequency domain multiplexing (OFDM) sub-carriers, and generating one or more signals that correspond to the field of the PHY header, including performing a frequency domain to time domain conversion based on the modulation data.

In still another embodiment, an apparatus comprises a network interface having a physical layer (PHY) processing unit configured to generate bits to be included in a field of a PHY header, duplicate the bits to generate duplicated bits, and parse the duplicated bits into a plurality of segments. The PHY processing unit is further configured to, for each segment, interleave duplicated bits within the segment without interleaving duplicated bits from other segments. The PHY processing unit is further still configured to after interleaving duplicated bits, generate modulation data based on the duplicated bits, the modulation data corresponding to a plurality of orthogonal frequency domain multiplexing (OFDM) sub-carriers. The network interface is configured to generate one or more signals that correspond to the field of the PHY header, wherein generating the one or more signals includes performing a frequency domain to time domain conversion based on the modulation data.

### BRIEF DESCRIPTION OF THE DRAWINGS

FIG. 1 is a block diagram of an example wireless local area network (WLAN), according to an embodiment.

FIG. 2 is a diagram of an example physical layer (PHY) data unit format, according to an embodiment.

FIG. 3 is a block diagram of a transmit portion of an example PHY processing unit for generating a field of PHY header, according to an embodiment.

FIG. 4 is a diagram illustrating a bit repetition/duplication technique utilized by the PHY processing unit of FIG. 3, according to an embodiment.

FIG. 5 is a block diagram of a transmit portion of another example PHY processing unit for generating a field of PHY header, according to another embodiment.

FIG. 6 is a flow diagram of an example method for generating a field of PHY header, according to an embodiment.

FIG. 7 is a block diagram of a transmit portion of yet another example PHY processing unit for generating a field of PHY header, according to yet another embodiment.

FIG. 8 is a diagram illustrating a bit repetition/duplication technique utilized by the PHY processing unit of FIG. 7, according to an embodiment.

FIG. 9 is a block diagram of a transmit portion of another example PHY processing unit for generating a field of PHY header, according to another embodiment.

FIG. 10 is a flow diagram of another example method for generating a field of PHY header, according to an embodiment.

Like reference symbols in the various drawings indicate like elements.

### DETAILED DESCRIPTION

In embodiments described below, a wireless network device such as an access point (AP) of a wireless local area network (WLAN) and one or more client stations communicate with one another by transmitting and receiving packets including a physical layer (PHY) header. Embodiments of techniques for generating a field of the PHY header, at least in some communication modes, are discussed below. For example, in some embodiments relating to the IEEE 802.11 ac Standard, the field of the PHY header is generated for a communication mode in which data units are modulated using orthogonal frequency division multiplexing (OFDM) for a wireless local area network (WLAN) communication channel having a width of 160 MHz. In other embodiments, however, the same or similar techniques are utilized with other communication protocols and/or with other suitable channel bandwidths.

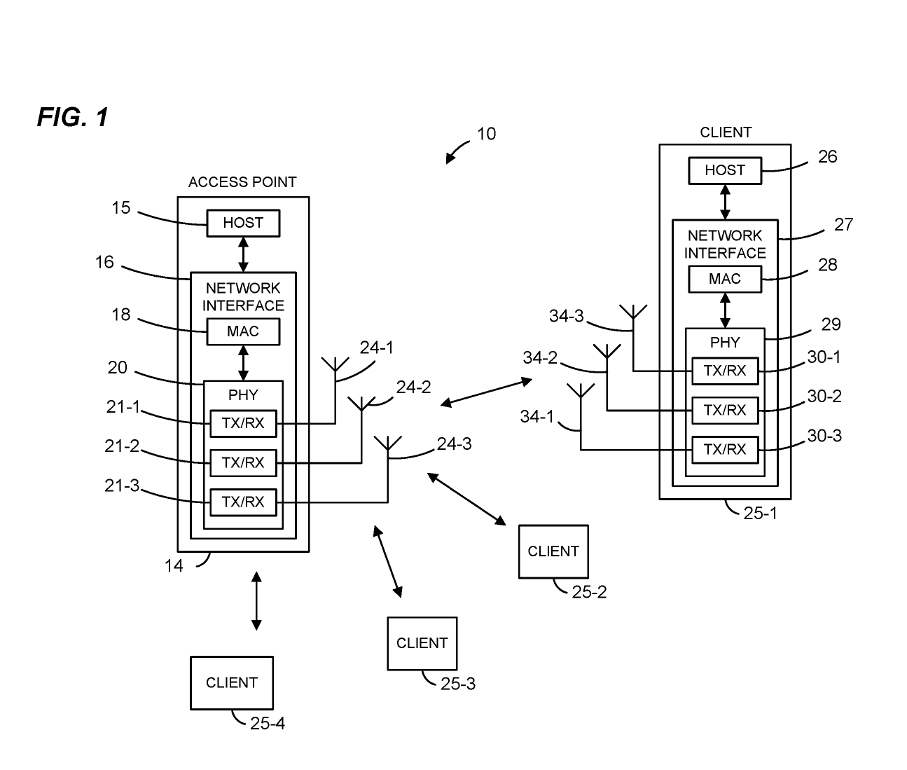

FIG. 1 is a block diagram of an example WLAN 10 including an access point (AP) 14, according to an embodiment. The AP 14 includes a host processor 15 coupled to a network interface 16. The network interface 16 includes a medium access control (MAC) processing unit 18 and a PHY processing unit 20. The PHY processing unit 20 includes a plurality of transceivers 21, and the transceivers 21 are coupled to a plurality of antennas 24. Although three transceivers 21 and three antennas 24 are illustrated in FIG. 1, the AP 14 may include different numbers (e.g., 1, 2, 4, 5, etc.) of transceivers and antennas in other embodiments. Additionally, although the AP 14 is illustrated as having the same number of transceivers 21 and antennas 24, in other embodiments the AP 14 may include a number of transceivers that is different than a number of antennas. For example, in some embodiments, the AP 14 may include more antennas than transceivers and may employ antenna switching techniques.

The WLAN 10 further includes a plurality of client stations 25. Although four client stations 25 are illustrated in FIG. 1, the WLAN 10 may include different numbers (e.g., 1, 2, 3, 5, 6, etc.) of client stations in various scenarios and embodiments. The client station 25-1 includes a host processor 26 coupled to a network interface 27. The network interface 27 includes a MAC processing unit 28 and a PHY processing unit 29. The PHY processing unit 29 includes a plurality of transceivers 30, and the transceivers 30 are coupled to a plurality of antennas 34. Although three transceivers 30 and three antennas 34 are illustrated in FIG. 1, the client station 25-1 may include different numbers (e.g., 1, 2, 4, 5, etc.) of transceivers and antennas in other embodiments. Additionally, although the client station 25-1 is illustrated as having the same number of transceivers 30 and antennas 34, in other embodiments the client station 25-1 may include a number of transceivers that is different than a number of antennas. For example, in some embodiments, the client station 25-1 may include more antennas than transceivers and may employ antenna switching techniques.

In some embodiments, one, some, or all of the client stations 25-2, 25-3, and 25-4 has/have a structure the same as or similar to the client station 25-1. In these embodiments, the client stations 25 structured the same as or similar to the client station 25-1 have the same or a different number of transceivers and antennas. For example, the client station 25-2 has only two transceivers and two antennas, according to an embodiment. As another example, the client station 25-2 has two transceivers and four antennas and utilizes antenna switching techniques, according to another embodiment.

In various embodiments, the PHY processing unit 20 of the AP 14 is configured to generate data units having PHY headers as discussed in more detail below. The transceiver(s) 21 is/are configured to transmit the generated data units via the antenna(s) 24. Similarly, the transceiver(s) 24 is/are configured to receive the data units via the antenna(s) 24. The PHY processing unit 20 of the AP 14 is also configured to process received data units having PHY headers, according to various embodiments.

In various embodiments, the PHY processing unit 29 of the client device 25-1 is configured to generate data units having PHY headers as discussed in more detail below. The transceiver(s) 30 is/are configured to transmit the generated data units via the antenna(s) 34. Similarly, the transceiver(s) 30 is/are configured to receive data units via the antenna(s) 34. The PHY processing unit 29 of the client device 25-1 is also configured to process received data units having PHY headers, according to various embodiments.

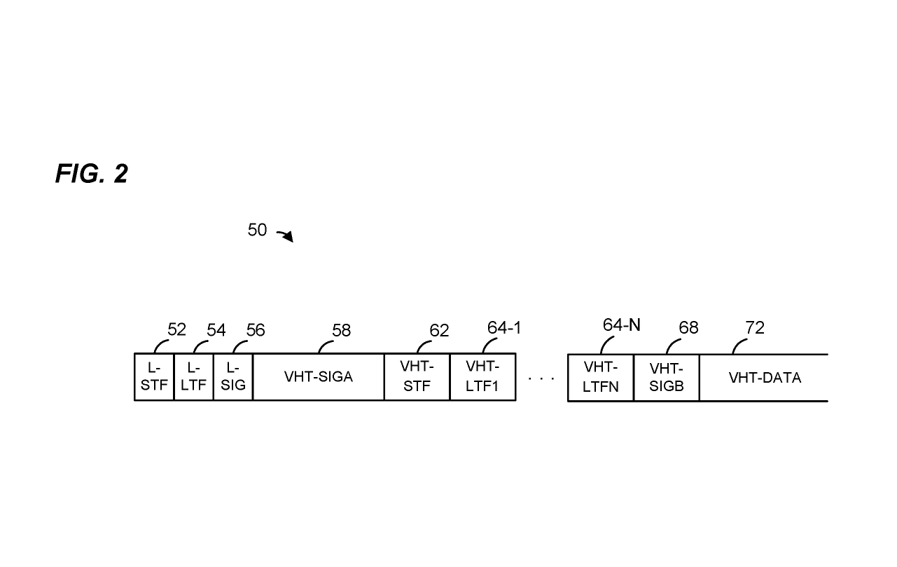

FIG. 2 is a diagram of an example data unit 50 that the AP 14 of FIG. 1 is configured to transmit to the client stations 25, according to an embodiment. In an embodiment, each of at least some of the client stations 25 is also configured to transmit data units of the format of FIG. 2 to the AP 14. The data unit 50 includes a preamble having a legacy short training field (L-STF) field 52, a legacy long training field (L-LTF) field 54, a legacy signal field (L-SIG) field 56, a first very high throughput signal field (VHT-SIGA) 58, a very high throughput short training field (VHT-STF) 62, N very high throughput long training fields (VHT-LTFs) 64, where N is an integer, and a second very high throughput signal field (VHT-SIGB) 68. The data unit 50 also includes a very high throughput data portion (VHT-DATA) 72. The data portion 72 includes service bits and information bits (not shown). Embodiments of techniques for generating the VHT-SIGB 68 are discussed below. In other embodiments, however, similar techniques are utilized to generate other suitable fields of other suitable PHY headers.

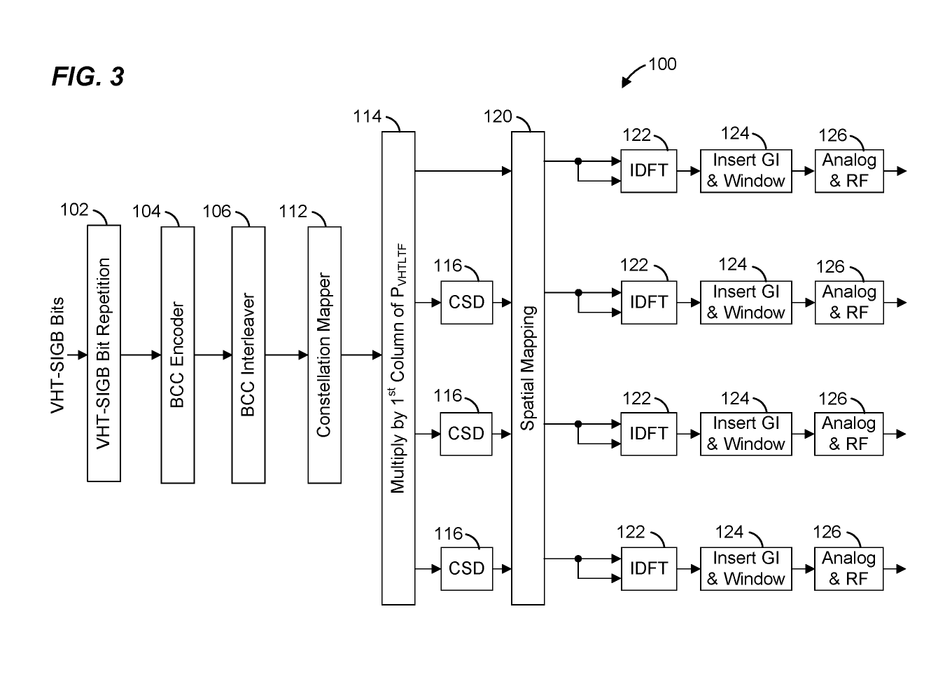

In some embodiments, the AP 14 and/or one or more client devices 25 are configured to utilize communication channels of different bandwidths in different communication modes. For example, the IEEE 802.11ac Standard permits use of communication channels of widths, 20 MHz, 40 MHz, 80 MHz and 160 MHz in different modes. FIG. 3 is a block diagram of a transmit portion of an example PHY processing unit 100 configured to generate the VHT-SIGB 68 (FIG. 2) in a transmission mode corresponding to a communication channel having a contiguous bandwidth of 160 MHz, according to an embodiment. In other embodiments, however, similar techniques and/or PHY processing units are utilized to generate other suitable fields for other suitable PHY headers, and/or for other suitable transmission modes corresponding to other suitable channel bandwidths. Referring to FIG. 1, the PHY processing unit 20 of AP 14 and the PHY processing unit 29 of client station 25-1 each include and/or are configured to perform the processing of the PHY processing unit 100, in one embodiment.

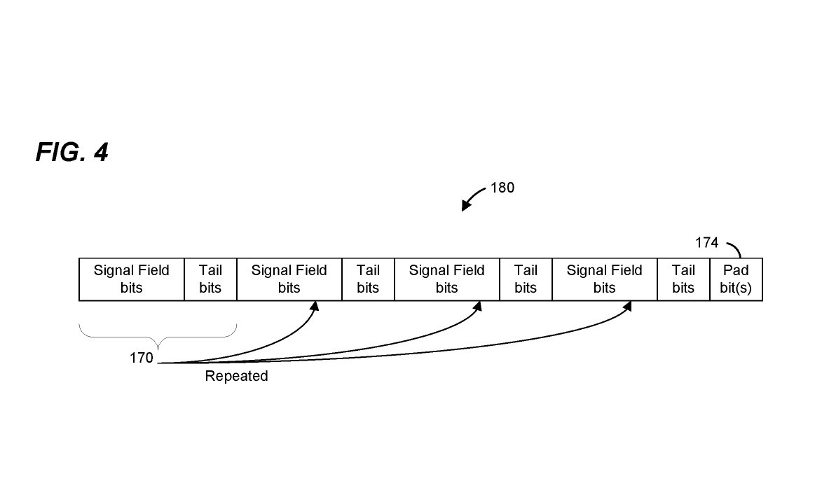

The PHY processing unit 100 generates control information bits (e.g., PHY-related bits) to be included in the VHT-SIGB field (e.g., signal field bits). In some embodiments, the PHY processing unit 100 is configured to add tail bits to the signal field bits. In some embodiments, the generated signal field bits correspond to a communication mode with a smaller channel bandwidth, and the generated signal field bits are repeated or duplicated for communication modes with larger bandwidths. Thus, in some embodiments, the PHY processing unit 100 includes a bit repetition or bit duplicator module 102. FIG. 4 is a diagram illustrating an example technique that is implemented by the bit repetition module 102, in an embodiment. In other embodiments, other bit repetition/duplication techniques are utilized. In other embodiments, no repetition/duplication is performed and the bit repetition module 102 may be omitted.

The PHY processing unit 100 generates a set 170 of signal field bits and tail bits. In an embodiment, the set 170 of signal field bits and tail bits corresponds to a channel having a bandwidth of 20 MHz. Thus, in some embodiments, the set 170 of signal field bits and tail bits are repeated/replicated/duplicated when using bandwidths of 40 MHz, 80 MHz, 160 MHz, etc., for example. The bit repetition module 102 repeats/replicates/duplicates the set 170 three times and adds one or more padding bits 174 (e.g., 1 padding bit or another suitable number of padding bits) such that a set 180 of duplicated bits is produced, the set 180 having four copies of the set 170. In an embodiment, the set 180 corresponds to a channel having a bandwidth of 80 MHz. In an embodiment, the set 170 includes 23 information bits and six tail bits, and only one padding bit 174 is added. Thus, in an embodiment, the set 180 includes 117 bits. In other embodiments, however, the set 170 includes other suitable numbers of information bits and tail bits, and/or different numbers of padding bits 174 are added.

Referring again to FIG. 3, an output of the bit repetition module 102 is coupled to a binary convolutional code (BCC) encoder 104, which performs BCC encoding on the duplicated bits. In an embodiment, the BCC encoder 104 utilizes an encoding rate of 1/2. For instance, continuing with the illustrative example above, if the set 180 includes 117 bits and the BCC encoder 104 employs a rate of 1/2, then the output of the BCC encoder 104 includes 234 bits. In other embodiments, other suitable encoding rates are utilized.

An output of the BCC encoder 104 is coupled to a BCC interleaver 106. The interleaver 106 interleaves bits (i.e., changes the order of the bits) to prevent long sequences of adjacent noisy bits from entering a decoder at the receiver. More specifically, the interleaver 106 maps adjacent bits (encoded by the BCC encoder 104) onto non-adjacent locations in the frequency domain or in the time domain. In some embodiments, the BCC encoder 104 and the BCC interleaver 106 are omitted.

The output of BCC interleaver 106 (or of duplication module 102 if BCC encoder 104 and the BCC interleaver 106 are omitted) is coupled to constellation mapper 112. In an embodiment, the constellation mapper 112 maps bits to constellation points corresponding to different subcarriers/tones of an OFDM symbol. In an embodiment, the constellation mapper 112 generates modulation data corresponding to frequency domain representations of modulated bits. For example, in an embodiment, the constellation mapper 112 maps bits to binary phase shift keying (BPSK) constellation points. In other embodiments, the constellation mapper 112 maps bits to constellation points corresponding to other suitable modulation schemes such phase shift keying (PSK), quadrature amplitude modulation (QAM), e.g., 4-QAM, 16-QAM, 64-QAM, 128-QAM, 256-QAM, etc.

An output of the constellation mapper 112 is provided to a multiplication module 114. In an embodiment, for a single user transmission, the multiplication module 114 is configured to multiply the modulation data with a first column of a mapping matrix P_{VHTLTF} to generate one or more spatial streams or space-time streams (hereinafter referred to as “spatial streams” for purposes of brevity). In an embodiment, the mapping matrix P_{VHTLTF} may vary depending on the number of spatial streams to be generated. For example, in an embodiment:

$${P}_{VHTLTF} = \{ \begin{matrix}{P}_{4 \times 4} , & {N}_{STS , total} \leq 4 \\ {P}_{6 \times 6} , & {N}_{STS , total} = 5 , 6 \\ {P}_{8 \times 8} , & {N}_{STS , total} = 7.8\end{matrix} \qquad Equation 1$$

where N_{STS} is the number of spatial streams to be generated, and

$$\begin{matrix}{P}_{4 \times 4} = [ \begin{matrix}1 & - 1 & 1 & 1 \\ 1 & 1 & - 1 & 1 \\ 1 & 1 & 1 & - 1 \\ - 1 & 1 & 1 & 1\end{matrix} ] , & Equation 2 \\ {P}_{6 \times 6} = [ \begin{matrix}1 & - 1 & 1 & 1 & 1 & - 1 \\ 1 & - {w}^{1} & {w}^{2} & {w}^{3} & {w}^{4} & - {w}^{5} \\ 1 & - {w}^{2} & {w}^{4} & {w}^{6} & {w}^{8} & - {w}^{10} \\ 1 & - {w}^{3} & {w}^{6} & {w}^{9} & {w}^{12} & - {w}^{15} \\ 1 & - {w}^{4} & {w}^{8} & {w}^{12} & {w}^{16} & - {w}^{20} \\ 1 & - {w}^{5} & {w}^{10} & {w}^{15} & {w}^{20} & - {w}^{25}\end{matrix} ] \\ where w = exp ( - j 2 π \text{/} 6 ) , and & Equation 3 \\ {P}_{8 \times 8} = [ \begin{matrix}{P}_{4 \times 4} & {P}_{4 \times 4} \\ {P}_{4 \times 4} & - {P}_{4 \times 4}\end{matrix} ] & Equation 4\end{matrix}$$

In other embodiments, other suitable mapping matrices are utilized. Although four spatial streams are illustrated in FIG. 3, other suitable numbers of spatial streams (e.g., 1, 2, 3, 5, 6, etc.) are utilized in other embodiments and/or scenarios.

Cyclic shift diversity (CSD) units 116 are coupled to the multiplication module 114. The CSD units 116 insert cyclic shifts into all but one of the spatial streams (if more than one spatial stream) to prevent unintentional beamforming.

A spatial mapping unit 120 maps the N_{STS} spatial streams to N_{TX} transmit chains, where N_{TX} is the number of transmit antennas to be employed. In various embodiments, spatial mapping includes one or more of: 1) direct mapping, in which constellation points from each spatial stream are mapped directly onto transmit chains (i.e., one-to-one mapping); 2) spatial expansion, in which vectors of constellation points from all spatial streams are expanded via matrix multiplication to produce inputs to the transmit chains; and 3) beamforming, in which each vector of constellation points from all of the spatial streams is multiplied by a matrix of steering vectors to produce inputs to the transmit chains.

Each modulation data output of the spatial mapping unit 120 corresponds to a respective transmit chain and also corresponds to single portion of the communication channel. As merely an illustrative example, in an embodiment in which a 160 MHz communication channel is to be utilized, each modulation data output of the spatial mapping unit 120 corresponds to an 80 MHz portion of the 160 MHz communication channel. In an embodiment, each modulation data output of the spatial mapping unit 120 is duplicated to provide modulation data for another portion of the communication channel. Continuing with the illustrative example above, in an embodiment, each modulation data output of the spatial mapping unit 120 is duplicated to provide modulation data for the other 80 MHz portion of the 160 MHz communication channel. Thus, after duplication of the modulation data, the modulation data for each transmit chain corresponds to the entire communication channel. Continuing with the illustrative example above, after duplication of the modulation data, the modulation data for each transmit chain corresponds to the 160 MHz communication channel, in an embodiment.

In some embodiments, appropriate phase shifts are also applied to the duplicated data. For example, in an embodiment,

$${ϒ}_{k , 160} = \{ \begin{matrix}1 , & k < - 192 \\ - 1 , & - 192 \leq k < 0 \\ 1 , & 0 \leq k < 64 \\ - 1 , & 64 \leq k\end{matrix} \qquad Equation 5$$

where [symbol] _{k,160} is the phase shift to be applied at each k-th sub-channel, and k is a sub-channel index.

After duplication of the modulation data, each set of modulation data is operated on by an inverse discrete-time Fourier transform (IDFT) calculation unit 122 (e.g., an inverse fast Fourier transform (IFFT) calculation unit) that converts a block of constellation points to a time-domain signal. The block of constellation points operated upon the IDFT calculation unit 122 corresponds to all of the sub-channels corresponding to the entire communication channel.

Outputs of the IDFT units 122 are provided to GI insertion and windowing units 124 that prepend to OFDM symbols, a guard interval (GI) portion, which is a circular extension of an OFDM symbol in an embodiment, and smooth the edges of OFDM symbols to increase spectral delay. Outputs of the GI insertion and windowing units 124 are provided to analog and radio frequency (RF) units 126 that convert the signals to analog signals and upconvert the signals to RF frequencies for transmission. The signals are transmitted and span the entire communication channel.

Although four transmit chains are illustrated in FIG. 3, the PHY processing unit 100 includes other suitable numbers of transmit chains (e.g., 1, 2, 3, 5, 6, 7, etc.). Also, in some scenarios, the PHY processing unit 100 does not utilize all transmit chains. As merely an illustrative example, in an embodiment in which the PHY processing unit 100 includes four transmit chains, the PHY processing unit 100 may utilize only two transmit chains or only three transmit chains, for example, if only two spatial streams are being utilized.

For embodiments and/or scenarios involving transmissions to multiple users, the processing performed is similar to that illustrated in FIG. 3 except for a few differences. For example, different VHT-SIGB bits are generated for each user, and the processing by blocks 102, 104, 106, 112, 114, and 116 is performed separately for each respective VHT-SIGB. Additionally, for each user, the multiplication module 114 multiplies the modulation data only with elements of the first column of P_{VHTLTF} corresponding to that user.

In the PHY processing unit 100, each transmit chain is configured to generate a transmit signal that spans the entire communication channel (e.g., spanning 160 MHz in one illustrative example). In other embodiments, however, the network interface device (e.g., network interface device 16 and/or network interface device 27) includes multiple radio frequency (RF) portions corresponding to different portions of the communication channel. For instance, as merely an illustrative example, the network interface device includes a first RF portion corresponding to first 80 MHz-wide portion of a 160 MHz-wide communication channel, and a second RF portion corresponding to second 80 MHz-wide portion of the 160 MHz-wide communication channel.

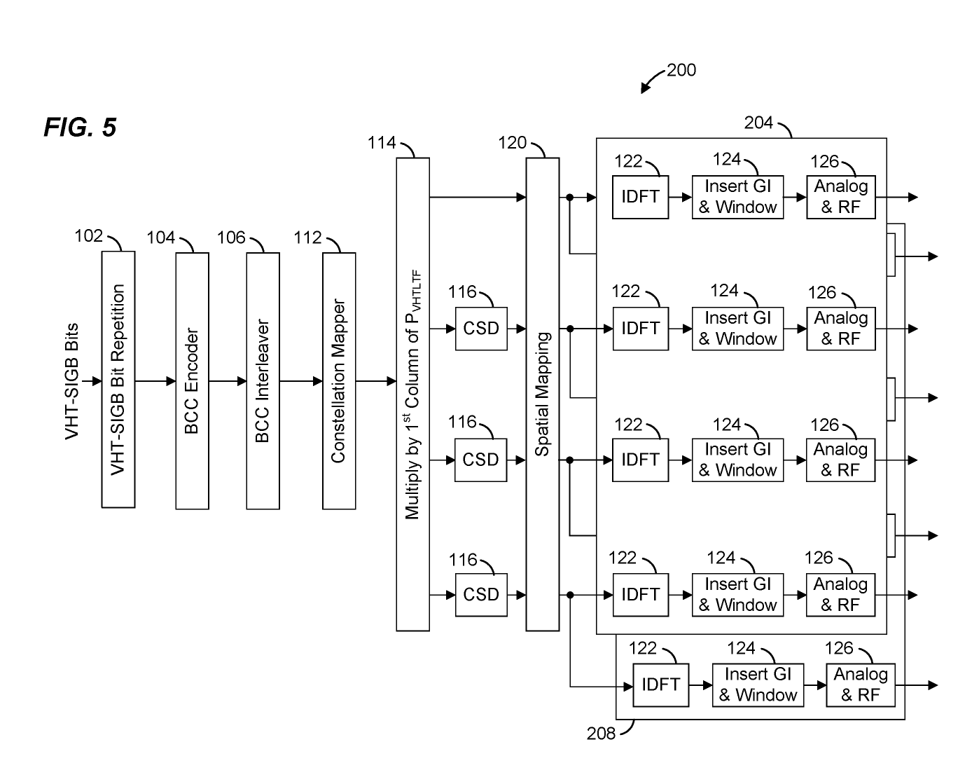

Referring now to FIG. 5, a PHY processing unit 200 includes a first transmitter portion 204 corresponding to a first frequency band of a communication channel and a second transmitter portion 208 corresponding to a second frequency band of the communication channel. As merely an illustrative embodiment in which the communication channel has a width of 160 MHz, the first transmitter portion 204 may correspond to a first 80 MHz frequency band and the second transmitter portion 208 may correspond to a second 80 MHz frequency band of the communication channel. In some embodiments and/or scenarios, the first frequency band is contiguous with the second frequency band. In other embodiments and/or scenarios, however, the first frequency band is not contiguous with the second frequency band. For example, there may be a gap in frequency between the first frequency band and the second frequency band, and the communication channel has a cumulative bandwidth equal to a sum of the bandwidth of the first frequency band and a bandwidth of the second frequency band.

The PHY processing unit 200 has many of the same elements of the PHY processing unit 100 of FIG. 3 and like-numbered elements are not discussed in detail merely for purposes of brevity. Referring to outputs of the spatial mapping unit 120, similar to the discussion above with respect to FIG. 3, each modulation data output of the spatial mapping unit 120 corresponds to a respective transmit chain of the first transmitter portion 204, and also corresponds to single portion of the communication channel. As merely an illustrative example, in an embodiment in which a 160 MHz communication channel is to be utilized, each modulation data output of the spatial mapping unit 120 corresponds to an 80 MHz portion of the 160 MHz communication channel. In an embodiment, each modulation data output of the spatial mapping unit 120 is duplicated to provide modulation data for another portion of the communication channel. Continuing with the illustrative example above, in an embodiment, each modulation data output of the spatial mapping unit 120 is duplicated to provide modulation data for the other 80 MHz portion of the 160 MHz communication channel.

Unlike the PHY processing unit 100 of FIG. 3, however, each modulation data output of the spatial mapping unit 120 is provided to a respective transmit chain of the first transmitter portion 204, whereas each duplicated modulation data is provided to a respective transmit chain of the second transmitter portion 208. In an embodiment in which the communication channel has a cumulative bandwidth of 160 MHz, respective outputs of the spatial mapping unit 120, each corresponding to the first 80 MHz portion of the channel, are provided to respective transmit chains of the first transmitter portion 204, and respective duplicated modulation data, each corresponding to the second 80 MHz portion of the channel, are provided to respective transmit chains of the second transmitter portion 208.

The block of constellation points operated upon by each IDFT calculation unit 122 corresponds to all of the sub-channels corresponding to the respective portion of the communication channel.

The signals output by each block 126 span only the respective bandwidth portion of the communication channel.

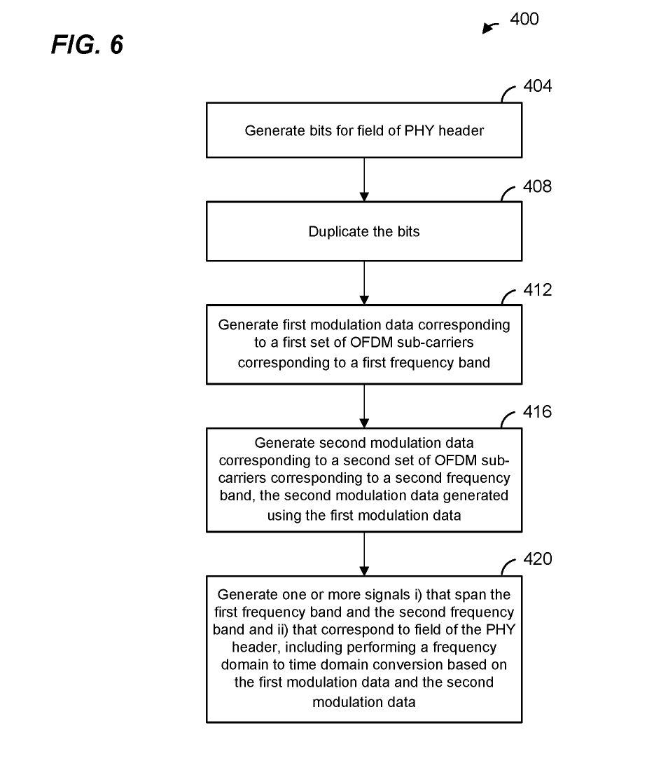

FIG. 6 is a flow diagram of an example method 400 for generating a field of a PHY header of a data unit, according to an embodiment. For example, in an embodiment, the method 400 is for generating a VHTSIGB field. In other embodiments, however, the method 400 may be utilized for generating another suitable PHY header field. The method 400 is implemented by the PHY processing unit 20, the PHY processing unit 29, the PHY processing unit 100, and/or the PHY processing unit 200 in various embodiments. Merely for illustrative purposes, the method 400 is described with reference to FIGS. 3 and 5. In other embodiments, however, the method 400 is implemented by another suitable PHY processing unit and/or network interface device different than those illustrated in FIGS. 1, 3, and 5.

At block 404, bits to be included in the field of the PHY header are generated. Block 404 includes generating information bits corresponding to PHY-related information, in an embodiment. Block 404 includes generating tail bits, in some embodiments. At block 408, the bits generated at block 404 are duplicated/replicated to generate duplicated bits. For example, in an embodiment, a duplication/replication technique such as illustrated in FIG. 4 is utilized. In other embodiments, another suitable duplication/replication technique is utilized. Block 408 may include adding one or more padding bits, in some embodiments. In an embodiment, the bit replication module 102 implements block 408.

At block 412, first modulation data are generated based on the duplicated bits, the first modulation data corresponding to a first set of orthogonal frequency domain multiplexing (OFDM) sub-carriers corresponding to a first frequency band. For example, the constellation mapper 112 generates modulation data corresponding duplicated bits generated by the bit replication module 102, in an embodiment. Block 412 includes applying a suitable modulation technique, in some embodiments. For example block 412 includes applying BPSK modulation, in an embodiment. In other embodiments, block 412 includes applying another suitable modulation technique such as PSK, QAM, etc. In an embodiment, the first modulation data include constellation points generated based on the duplicated bits.

At block second modulation data is generated using the first modulation data, the second modulation data corresponding to a second set of OFDM sub-carriers corresponding to a second frequency band. For example, as discussed above with respect to FIG. 3, prior to the IDFT units 122, the PHY processing unit 100/200 duplicates first modulation data corresponding to a first frequency portion to generate modulation data corresponding to a second frequency band, in an embodiment.

At block 420, one or more signals i) that span the first frequency band and the second frequency band and ii) that correspond to field of the PHY header are generated, including performing a frequency domain to time domain conversion based on the first modulation data and the second modulation data. The one or more signals may include multiple signals corresponding to different antennas, in some embodiments. Additionally or alternatively, the one or more signals may include one or more first signals that span the first frequency band but not the entire communication channel and one or more second signals that span the second frequency band but not the entire communication channel, in some embodiments.

In some embodiments, the method 400 may include additional processing. For instance, in some embodiments, the duplicated bits generated at block 408 may be BCC encoded, e.g., by the BCC encoder 104. In some embodiments, the duplicated bits generated at block 408 may be interleaved, e.g., by the BCC interleaver 106. In some embodiments, phase rotations may be applied to modulated data, such as described above.

In some embodiments, one or more blocks in FIG. 6 are omitted. For example, in some embodiments, bit repetition/duplication is omitted (i.e., block 404 is omitted) and the remaining processing is performed on the unduplicated/unreplicated PHY header field bits.

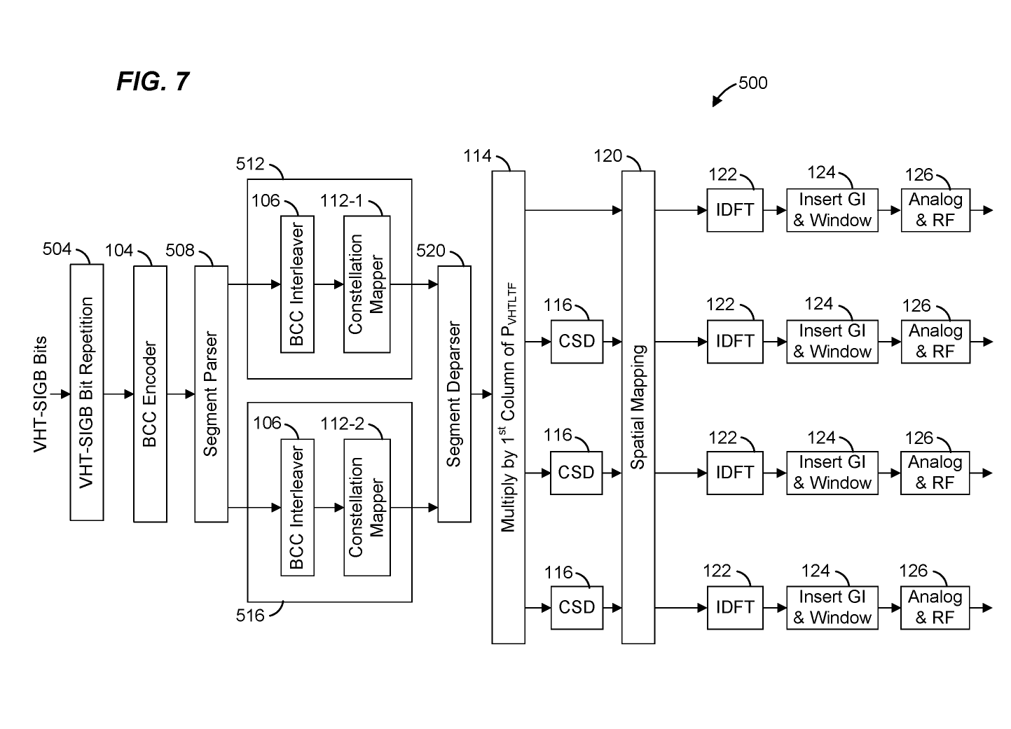

FIG. 7 is a block diagram of a transmit portion of an example PHY processing unit 500 configured to generate the VHT-SIGB 68 (FIG. 2) in a transmission mode corresponding to a communication channel having a contiguous bandwidth of 160 MHz, according to another embodiment. In other embodiments, however, similar techniques and/or PHY processing units are utilized to generate other suitable fields for other suitable PHY headers, and/or for other suitable transmission modes corresponding to other suitable channel bandwidths. Referring to FIG. 1, the PHY processing unit 20 of AP 14 and the PHY processing unit 29 of client station 25-1 each include and/or are configured to perform the processing of the PHY processing unit 500, in one embodiment. The PHY processing unit 500 has many of the same elements of the PHY processing unit 100 of FIG. 3 and at least some like-numbered elements are not discussed in detail merely for purposes of brevity.

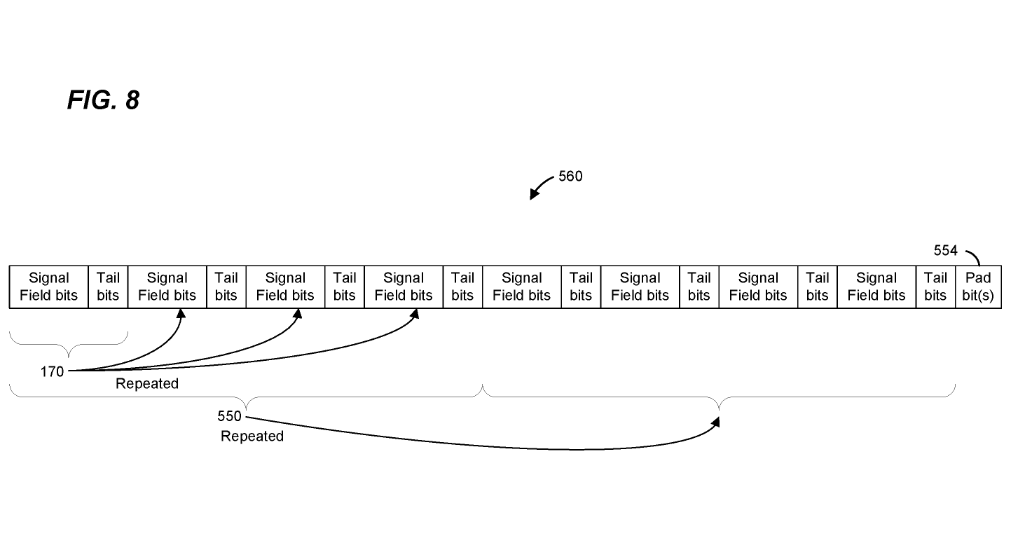

The PHY processing unit 500 generates control information bits (e.g., PHY-related bits) to be included in the VHT-SIGB field (e.g., signal field bits). In some embodiments, the PHY processing unit 500 is configured to add tail bits to the signal field bits. In some embodiments, the generated signal field bits correspond to a communication mode with a smaller channel bandwidth, and the generated signal field bits are repeated or duplicated for communication modes with larger bandwidths. Thus, in some embodiments, the PHY processing unit 500 includes a bit repetition or bit duplicator module 504. FIG. 8 is a diagram illustrating an example technique that is implemented by the bit repetition module 504, in an embodiment. In other embodiments, other bit repetition/duplication techniques are utilized. In other embodiments, no repetition/duplication is performed and the bit repetition module 504 may be omitted.

The PHY processing unit 500 generates the set 170 of signal field bits and tail bits, in an embodiment. In an embodiment, the set 170 of signal field bits and tail bits corresponds to a channel having a bandwidth of 20 MHz. Thus, in some embodiments, the set 170 of signal field bits and tail bits are repeated/duplicated when using bandwidths of 40 MHz, 80 MHz, 160 MHz, etc., for example. The bit repetition module 504 repeats/duplicates the set 170 three times to generate a set 550. Then, the set 550 is duplicated and one or more padding bits 554 are added (e.g., 1 padding bit or another suitable number of padding bits) such that a set 560 of duplicated bits is produced, the set 560 having eight copies of the set 170. In an embodiment, the set 560 corresponds to a channel having a bandwidth of 160 MHz. In an embodiment, the set 170 includes 23 information bits and six tail bits, and only one padding bit 554 is added. Thus, in an embodiment, the set 560 includes 234 bits. In other embodiments, however, the set 170 includes other suitable numbers of information bits and tail bits, and/or different numbers of padding bits 554 are added.

An output of the bit repetition module 504 is coupled to the BCC encoder 104, which performs BCC encoding on the duplicated bits. In an embodiment, the BCC encoder 104 utilizes an encoding rate of 1/2. For instance, continuing with the illustrative example above, if the set 180 includes 234 bits and the BCC encoder 104 employs a rate of 1/2, then the output of the BCC encoder 104 includes 468 bits. In other embodiments, other suitable encoding rates are utilized.

An output of the BCC encoder 104 is coupled to a segment parser 508. The segment parser 508 parses the output of the BCC encoder 104 into multiple segments. In an embodiment, the segment parser 508 parses the output of the BCC encoder 104 into two segments. As an illustrative example, the segment parser 508 parses the output of the BCC encoder 104 into two segments, each having 234 coded bits. In other embodiments, however, the segment parser 508 parses the output of the BCC encoder 104 into a different suitable number of segments. In an embodiment, the segment parser 508 parses the output of the BCC encoder 104 into the multiple segments using a round robin technique. In other embodiments, the segment parser 508 utilizes another suitable technique.

Each segment is processed by a respective segment processor. For example, in the embodiment illustrated in FIG. 7, a first segment is processed by a first segment processor 512, and a second segment is processed by a second segment processor 516. Each segment processor includes a respective BCC interleaver 106 and a respective constellation mapper 112.

Each BCC interleaver 106 interleaves bits as discussed above, and the output of each BCC interleaver 106 (or of the segment parser 508 if the BCC encoder 104 and the BCC interleaver 106 are omitted) is coupled to a respective constellation mapper 112 that operates in a manner discussed above. In an illustrative embodiment, each constellation mapper 112 maps a respective set of 234 bits to a respective set of 234 BPSK constellation points.

Outputs of the constellation mappers 112 are provided to a segment deparser 520 that merges the outputs of the multiple constellation mappers 112. In an illustrative embodiments, the segment deparser 520 that a set of 234 constellation points from the first segment processor 512 with a set of 234 constellation points from the second segment processor 516.

An output of the segment deparser 520 is provided to a multiplication module 114. In an embodiment, for a single user transmission, the multiplication module 114 is configured to multiply the modulation data with the first column of the mapping matrix P_{VHTLTF} to generate one or more spatial streams as discussed above.

In some embodiments, the order of the multiplication module 114 and the segment deparser 520 are reversed.

Cyclic shift diversity (CSD) units 116 are coupled to the multiplication module 114. The CSD units 116 insert cyclic shifts into all but one of the spatial streams (if more than one spatial stream) to prevent unintentional beamforming.

A spatial mapping unit 120 maps the N_{STS} spatial streams to N_{TX} transmit chains as discussed above. Each modulation data output of the spatial mapping unit 120 corresponds to a respective transmit chain and also corresponds to the entire communication channel. As merely an illustrative example, in an embodiment in which a 160 MHz communication channel is to be utilized, each modulation data output of the spatial mapping unit 120 corresponds to 160 MHz. In some embodiments, appropriate phase shifts are also applied to outputs of the spatial mapping unit.

Each set of modulation data is operated on by the IDFT calculation unit 122 that converts a block of constellation points to a time-domain signal. The block of constellation points operated upon the IDFT calculation unit 122 corresponds to all of the sub-channels corresponding to the entire communication channel. Outputs of the IDFT units 122 are provided to GI insertion and windowing units 124 that prepend to OFDM symbols, a GI portion. Outputs of the GI insertion and windowing units 124 are provided to RF units 126 that convert the signals to analog signals and upconvert the signals to RF frequencies for transmission. The signals are transmitted and span the entire communication channel.

Although four transmit chains are illustrated in FIG. 7, the PHY processing unit 500 includes other suitable numbers of transmit chains (e.g., 1, 2, 3, 5, 6, 7, etc.). Also, in some scenarios, the PHY processing unit 500 does not utilize all transmit chains. As merely an illustrative example, in an embodiment in which the PHY processing unit 500 includes four transmit chains, the PHY processing unit 500 may utilize only two transmit chains or only three transmit chains, for example, if only two spatial streams are being utilized.

For embodiments and/or scenarios involving transmissions to multiple users, the processing performed is similar to that illustrated in FIG. 7 except for a few differences. For example, different VHT-SIGB bits are generated for each user, and the processing by blocks 504, 104, 508, 106, 112, 520, 114, and 116 is performed separately for each respective VHT-SIGB. Additionally, for each user, the multiplication module 114 multiplies the modulation data only with elements of the first column of P_{VHTLTF} corresponding to that user.

In the PHY processing unit 100, each transmit chain is configured to generate a transmit signal that spans the entire communication channel (e.g., spanning 160 MHz in one illustrative example). In other embodiments, however, the network interface device (e.g., network interface device 16 and/or network interface device 27) includes multiple radio frequency (RF) portions corresponding to different portions of the communication channel. For instance, as merely an illustrative example, the network interface device includes a first RF portion corresponding to first 80 MHz-wide portion of a 160 MHz-wide communication channel, and a second RF portion corresponding to second 80 MHz-wide portion of the 160 MHz-wide communication channel.

In the PHY processing unit 500, each transmit chain is configured to generate a transmit signal that spans the entire communication channel (e.g., spanning 160 MHz in one illustrative example). In other embodiments, however, the network interface device (e.g., network interface device 16 and/or network interface device 27) includes multiple transmit chains each capable of generating signal that span only a portion of the communication channel, but together generate signals that cumulatively span the communication channel. For instance, as merely an illustrative example, the network interface device includes multiple transmit chains that each generate signals up 80 MHz-wide, but can be used in conjunction to generate a signal that has a cumulative bandwidth of 160 MHz.

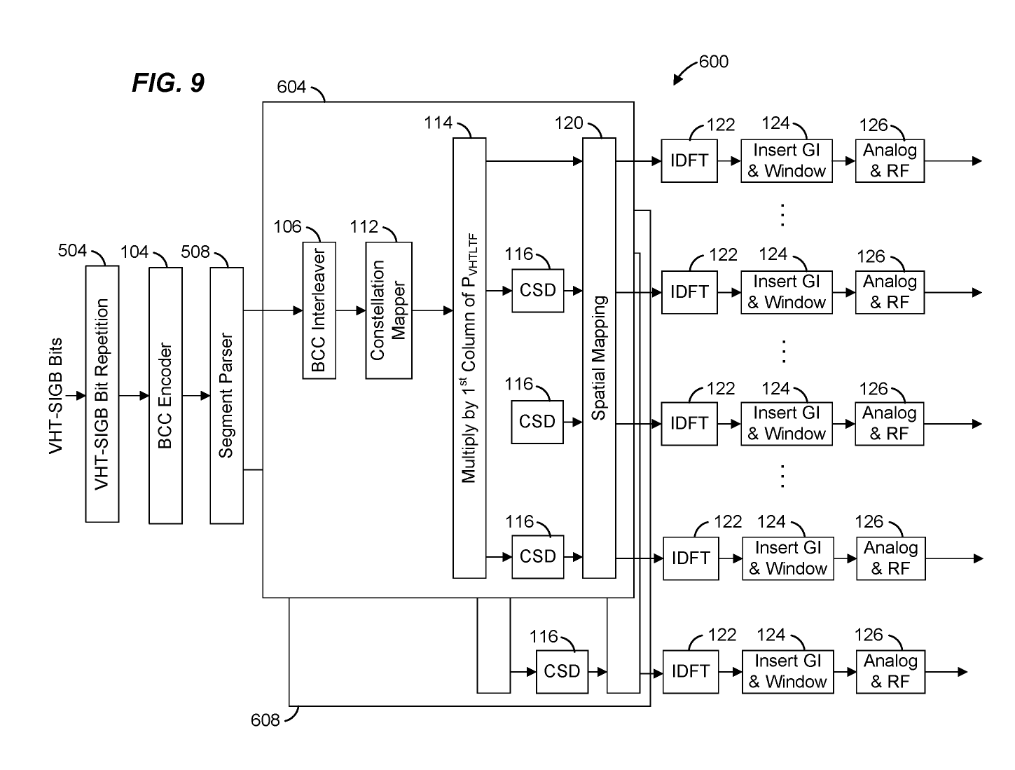

Referring now to FIG. 9, a PHY processing unit 600 includes many of the same elements of the PHY processing unit 500 of FIG. 7 and at least some like-numbered elements are not discussed in detail merely for purposes of brevity. The PHY processing unit 600 includes a first transmitter portion 604 corresponding to a first frequency band of a communication channel and a second transmitter portion 608 corresponding to a second frequency band of the communication channel. Additionally, the PHY processing unit 600 does not utilize a segment deparser.

As merely an illustrative embodiment in which the communication channel has a width of 160 MHz, the first transmitter portion 604 may correspond to a first 80 MHz frequency band and the second transmitter portion 608 may correspond to a second 80 MHz frequency band of the communication channel. In some embodiments and/or scenarios, the first frequency band is contiguous with the second frequency band. In other embodiments and/or scenarios, however, the first frequency band is not contiguous with the second frequency band. For example, there may be a gap in frequency between the first frequency band and the second frequency band, and the communication channel has a cumulative bandwidth equal to a sum of the bandwidth of the first frequency band and a bandwidth of the second frequency band.

The first transmitter portion 604 includes a respective BCC interleaver 106, a respective constellation mapper 112, a respective multiplication module 114, respective CSD units 116, and a respective spatial mapping unit 120. Referring to outputs of the spatial mapping unit 120, each modulation data output of the spatial mapping unit 120 of the first transmitter portion 604 corresponds to a respective transmit chain, and also corresponds to single portion of the communication channel. As merely an illustrative example, in an embodiment in which a 160 MHz communication channel is to be utilized, each modulation data output of the first transmitter portion 604 corresponds to a first 80 MHz portion of the 160 MHz communication channel. Continuing with the illustrative example above, in an embodiment, each modulation data output of the second transmitter portion 608 for a second 80 MHz portion of the 160 MHz communication channel. Thus, each modulation data output of the first transmit portion 604 and the second transmit portion 608 is provided to a respective transmit chain.

The block of constellation points operated upon by each IDFT calculation unit 122 corresponds to all of the sub-channels corresponding to the respective portion of the communication channel.

The signals output by each block 126 span only the respective bandwidth portion of the communication channel.

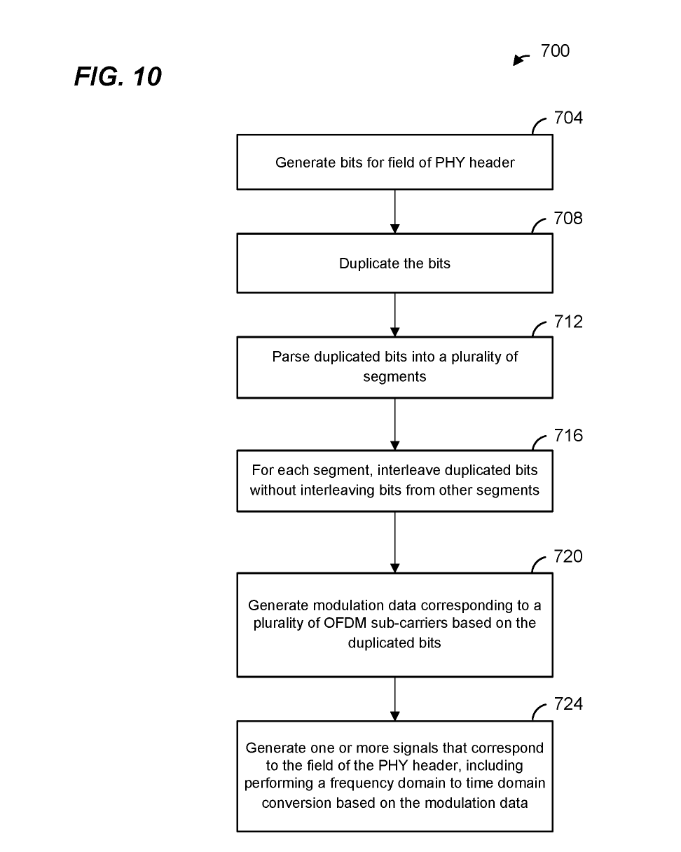

FIG. 10 is a flow diagram of an example method 700 for generating a field of a PHY header of a data unit, according to an embodiment. For example, in an embodiment, the method 700 is for generating a VHTSIGB field. In other embodiments, however, the method 700 may be utilized for generating another suitable PHY header field. The method 700 is implemented by the PHY processing unit 20, the PHY processing unit 29, the PHY processing unit 500, and/or the PHY processing unit 600 in various embodiments. Merely for illustrative purposes, the method 700 is described with reference to FIGS. 7 and 9. In other embodiments, however, the method 400 is implemented by another suitable PHY processing unit and/or network interface device different than those illustrated in FIGS. 1, 7, and 9.

At block 704, bits to be included in the field of the PHY header are generated. Block 704 includes generating information bits corresponding to PHY-related information, in an embodiment. Block 704 includes generating tail bits, in some embodiments. At block 708, the bits generated at block 704 are duplicated/replicated to generate duplicated bits. For example, in an embodiment, a duplication/replication technique such as illustrated in FIG. 8 is utilized. In other embodiments, another suitable duplication/replication technique is utilized. Block 708 may include adding one or more padding bits, in some embodiments. In an embodiment, the bit replication module 504 implements block 708.

At block 712, the duplicated bits are parsed into a plurality of segments. In an embodiment, the segment parser 508 implements block 712. At block 716, for each segment, duplicated bits within the segment are interleaved without interleaving duplicated bits from other segments. In an embodiment, the BCC interleavers 106 corresponding to different segments implement block 716.

At block 720, modulation data based on the duplicated bits is generated, the modulation data corresponding to a plurality of orthogonal frequency domain multiplexing (OFDM) sub-carriers. In an embodiment, the constellation mappers 112 corresponding to different segments implement block 720.

At block 724, one or more signals that correspond to the field of the PHY header are generated, including performing a frequency domain to time domain conversion based on the modulation data. In an embodiment, the IDFT calculation units 122, as well as the units 124 and 126 implement block 724. The one or more signals may include multiple signals corresponding to different antennas, in some embodiments. Additionally or alternatively, the one or more signals may include one or more first signals that span the first frequency band but not the entire communication channel and one or more second signals that span the second frequency band but not the entire communication channel, in some embodiments.

In some embodiments, the method 400 may include additional processing. For instance, in some embodiments, the duplicated bits generated at block 708 may be BCC encoded, e.g., by the BCC encoder 104. In some embodiments, modulation data generated at block 720 is deparsed, and block 724 is performed after deparsing. In some embodiments, phase rotations may be applied to modulated data, such as described above.

In some embodiments, one or more blocks in FIG. 10 are omitted. For example, in some embodiments, bit repetition/duplication is omitted (i.e., block 708 is omitted) and the remaining processing is performed on the unduplicated/unreplicated PHY header field bits. In some embodiments, block 716 is omitted.

Additionally, further aspects of the present invention relate to one or more of the following clauses.

In an embodiment, a method of generating a field of a physical layer (PHY) header of a data unit includes generating bits to be included in the field, and duplicating the bits to generate duplicated bits. The method also includes generating first modulation data based on the duplicated bits, the first modulation data corresponding to a first set of orthogonal frequency domain multiplexing (OFDM) sub-carriers corresponding to a first frequency band, and generating second modulation data using the first modulation data, the second modulation data corresponding to a second set of OFDM sub-carriers corresponding to a second frequency band. The method additionally includes generating one or more signals i) that span the first frequency band and the second frequency band and ii) that correspond to field of the PHY header, wherein generating the one or more signals includes performing a frequency domain to time domain conversion based on the first modulation data and the second modulation data.

In other embodiments, the method includes any suitable combination of one or more of the following features.

The first frequency band and the second frequency band are contiguous.

Generating the one or more signals comprises generating a single signal that spans the first frequency band and the second frequency band.

Generating the one or more signals comprises generating a plurality of signals that include the single signal.

Each signal in the plurality of signals i) spans the first frequency band and the second frequency band, and ii) corresponds to a respective transmit antenna.

Generating the one or more signals comprises generating a first signal that spans the first frequency band, and generating a second signal that spans the second frequency band.

Generating the one or more signals comprises generating a first plurality of signals that include the first signal, wherein each signal in the first plurality of signals spans the first frequency band, and corresponds to a respective transmit antenna, and generating a second plurality of signals that include the second signal, wherein each signal in the second plurality of signals spans the second frequency band, and corresponds to a respective transmit antenna.

In another embodiment, an apparatus comprises a network interface having a physical layer (PHY) processing unit configured to generate bits to be included in a field of a PHY header, and duplicate the bits to generate duplicated bits. The PHY processing unit is further configured to generate first modulation data based on the duplicated bits, the first modulation data corresponding to a first set of orthogonal frequency domain multiplexing (OFDM) sub-carriers corresponding to a first frequency band, an generate second modulation data using the first modulation data, the second modulation data corresponding to a second set of OFDM sub-carriers corresponding to a second frequency band. The network interface is configured to generate one or more signals i) that span the first frequency band and the second frequency band and ii) that correspond to field of the PHY header, including performing a frequency domain to time domain conversion based on the first modulation data and the second modulation data.

In other embodiments, the apparatus includes any suitable combination of one or more of the following features.

The first frequency band and the second frequency band are contiguous.

The network interface is configured to generate the one or more signals at least by generating a single signal that spans the first frequency band and the second frequency band.

The network interface is configured to generate the one or more signals at least by generating a plurality of signals that include the single signal.

Each signal in the plurality of signals i) spans the first frequency band and the second frequency band, and ii) corresponds to a respective transmit antenna.

The network interface is configured to generate the one or more signals at least by generating a first signal that spans the first frequency band, and generating a second signal that spans the second frequency band.

The network interface is configured to generate the one or more signals at least by generating a first plurality of signals that include the first signal, wherein each signal in the first plurality of signals spans the first frequency band, and corresponds to a respective transmit antenna, and generating a second plurality of signals that include the second signal, wherein each signal in the second plurality of signals spans the second frequency band, and corresponds to a respective transmit antenna.

In yet another embodiment, a method of generating a field of a physical layer (PHY) header of a data unit includes generating bits to be included in the field, duplicating the bits to generate duplicated bits, and parsing the duplicated bits into a plurality of segments. The method also includes for each segment, interleaving duplicated bits within the segment without interleaving duplicated bits from other segments. The method additionally includes after interleaving duplicated bits, generating modulation data based on the duplicated bits, the modulation data corresponding to a plurality of orthogonal frequency domain multiplexing (OFDM) sub-carriers, and generating one or more signals that correspond to the field of the PHY header, including performing a frequency domain to time domain conversion based on the modulation data.

In other embodiments, the method includes any suitable combination of one or more of the following features.

The method further comprises after interleaving duplicated bits, deparsing the duplicated bits from the plurality of segments.

Generating the one or more signals comprises generating a plurality of signals.

Each signal in the plurality of signals corresponds to a respective transmit antenna.

A first segment in the plurality of segments corresponds to a first frequency band.

A second segment in the plurality of segments corresponds to a second frequency band.

Generating the one or more signals comprises generating a first signal that spans the first frequency band, and generating a second signal that spans the second frequency band.

Generating the one or more signals comprises generating a first plurality of signals that include the first signal, wherein each signal in the first plurality of signals spans the first frequency band, and corresponds to a respective transmit antenna, and generating a second plurality of signals that include the second signal, wherein each signal in the second plurality of signals spans the second frequency band, and corresponds to a respective transmit antenna.

In still another embodiment, an apparatus comprises a network interface having a physical layer (PHY) processing unit configured to generate bits to be included in a field of a PHY header, duplicate the bits to generate duplicated bits, and parse the duplicated bits into a plurality of segments. The PHY processing unit is further configured to, for each segment, interleave duplicated bits within the segment without interleaving duplicated bits from other segments. The PHY processing unit is further still configured to after interleaving duplicated bits, generate modulation data based on the duplicated bits, the modulation data corresponding to a plurality of orthogonal frequency domain multiplexing (OFDM) sub-carriers. The network interface is configured to generate one or more signals that correspond to the field of the PHY header, wherein generating the one or more signals includes performing a frequency domain to time domain conversion based on the modulation data.

In other embodiments, the apparatus includes any suitable combination of one or more of the following features.

The PHY processing unit is configured to after interleaving duplicated bits, deparse the duplicated bits from the plurality of segments.

The network interface is configured to generate the one or more signals at least by generating a plurality of signals.

Each signal in the plurality of signals corresponds to a respective transmit antenna.

A first segment in the plurality of segments corresponds to a first frequency band.

A second segment in the plurality of segments corresponds to a second frequency band.

The network interface is configured to generate the one or more signals at least by generating a first signal that spans the first frequency band, and generating a second signal that spans the second frequency band.

The network interface is configured to generate the one or more signals at least by generating a first plurality of signals that include the first signal, wherein each signal in the first plurality of signals spans the first frequency band, and corresponds to a respective transmit antenna, and generating a second plurality of signals that include the second signal, wherein each signal in the second plurality of signals spans the second frequency band, and corresponds to a respective transmit antenna.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory such as on a magnetic disk, an optical disk, or other storage medium, in a RAM or ROM or flash memory, processor, hard disk drive, optical disk drive, tape drive, etc. Likewise, the software or firmware instructions may be delivered to a user or a system via any known or desired delivery method including, for example, on a computer readable disk or other transportable computer storage mechanism or via communication media. Communication media typically embodies computer readable instructions, data structures, program modules or other data in a modulated data signal such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Thus, the software or firmware instructions may be delivered to a user or a system via a communication channel such as a telephone line, a DSL line, a cable television line, a fiber optics line, a wireless communication channel, the Internet, etc. (which are viewed as being the same as or interchangeable with providing such software via a transportable storage medium). The software or firmware instructions may include machine readable instructions that, when executed by the processor, cause the processor to perform various acts.

When implemented in hardware, the hardware may comprise one or more of discrete components, an integrated circuit, an application-specific integrated circuit (ASIC), etc.

While the present invention has been described with reference to specific examples, which are intended to be illustrative only and not to be limiting of the invention, changes, additions and/or deletions may be made to the disclosed embodiments without departing from the scope of the claims.

1. A method of generating a field of a physical layer (PHY) header of a data unit, the method comprising:
generating bits to be included in the field;
duplicating the bits to generate duplicated bits;
generating first modulation data based on the duplicated bits, the first modulation data corresponding to a first set of orthogonal frequency domain multiplexing (OFDM) sub-carriers corresponding to a first frequency band;
generating second modulation data using the first modulation data, the second modulation data corresponding to a second set of OFDM sub-carriers corresponding to a second frequency band; and
generating one or more signals i) that span the first frequency band and the second frequency band and ii) that correspond to field of the PHY header, including performing a frequency domain to time domain conversion based on the first modulation data and the second modulation data.

2. The method of claim 1, wherein:
the first frequency band and the second frequency band are contiguous; and
generating the one or more signals comprises generating a single signal that spans the first frequency band and the second frequency band.

3. The method of claim 2, wherein:
generating the one or more signals comprises generating a plurality of signals that include the single signal; and
each signal in the plurality of signals
i) spans the first frequency band and the second frequency band, and
ii) corresponds to a respective transmit antenna.

4. The method of claim 1, wherein:
generating the one or more signals comprises:
generating a first signal that spans the first frequency band, and
generating a second signal that spans the second frequency band.

5. The method of claim 4, wherein generating the one or more signals comprises:
generating a first plurality of signals that include the first signal, wherein each signal in the first plurality of signals
spans the first frequency band, and
corresponds to a respective transmit antenna, and
generating a second plurality of signals that include the second signal, wherein each signal in the second plurality of signals
spans the second frequency band, and
corresponds to a respective transmit antenna.

6. An apparatus comprising:
a network interface device having one or more integrated circuits configured to
generate bits to be included in a field of a physical layer (PHY) header,
duplicate the bits to generate duplicated bits,
generate first modulation data based on the duplicated bits, the first modulation data corresponding to a first set of orthogonal frequency domain multiplexing (OFDM) sub-carriers corresponding to a first frequency band, and
generate second modulation data using the first modulation data, the second modulation data corresponding to a second set of OFDM sub-carriers corresponding to a second frequency band;
wherein the one or more integrated circuits are configured to generate one or more signals i) that span the first frequency band and the second frequency band and ii) that correspond to field of the PHY header, wherein generating the one or more signals includes performing a frequency domain to time domain conversion based on the first modulation data and the second modulation data.

7. The apparatus of claim 6, wherein:
the first frequency band and the second frequency band are contiguous; and
the one or more integrated circuits are configured to generate the one or more signals at least by generating a single signal that spans the first frequency band and the second frequency band.

8. The apparatus of claim 7, wherein:
the one or more integrated circuits are configured to generate the one or more signals at least by generating a plurality of signals that include the single signal; and
each signal in the plurality of signals
i) spans the first frequency band and the second frequency band, and
ii) corresponds to a respective transmit antenna.

9. The apparatus of claim 6, wherein:
the one or more integrated circuits are configured to generate the one or more signals at least by:
generating a first signal that spans the first frequency band, and
generating a second signal that spans the second frequency band.

10. The apparatus of claim 9, wherein the one or more integrated circuits are configured to generate the one or more signals at least by:
generating a first plurality of signals that include the first signal, wherein each signal in the first plurality of signals
spans the first frequency band, and
corresponds to a respective transmit antenna, and
generating a second plurality of signals that include the second signal, wherein each signal in the second plurality of signals
spans the second frequency band, and
corresponds to a respective transmit antenna.

11. A tangible, non-transitory computer readable medium, or media, storing machine readable instructions that, when executed by one or more processors, cause the one or more processors to:
generate bits to be included in a field of a physical layer (PHY) header;
duplicate the bits to generate duplicated bits;
generate first modulation data based on the duplicated bits, the first modulation data corresponding to a first set of orthogonal frequency domain multiplexing (OFDM) sub-carriers corresponding to a first frequency band;
generate second modulation data using the first modulation data, the second modulation data corresponding to a second set of OFDM sub-carriers corresponding to a second frequency band; and
generate one or more signals i) that span the first frequency band and the second frequency band and ii) that correspond to the field of the PHY header, wherein generating the one or more signals includes performing a frequency domain to time domain conversion based on the first modulation data and the second modulation data.

12. The computer readable medium, or media, of claim 11, wherein:
the first frequency band and the second frequency band are contiguous; and
computer readable medium, or media, further stores instructions that, when executed by the one or more processors, cause the one or more processors to generate the one or more signals at least by generating a single signal that spans the first frequency band and the second frequency band.

13. The computer readable medium, or media, of claim 12, further storing instructions that, when executed by the one or more processors, cause the one or more processors to:
generate the one or more signals at least by generating a plurality of signals that include the single signal; and
each signal in the plurality of signals
i) spans the first frequency band and the second frequency band, and
ii) corresponds to a respective transmit antenna.

14. The computer readable medium, or media, of claim 11, further storing instructions that, when executed by the one or more processors, cause the one or more processors to generate the one or more signals at least by:
generating a first signal that spans the first frequency band, and
generating a second signal that spans the second frequency band.

15. The computer readable medium, or media, of claim 14, further storing instructions that, when executed by the one or more processors, cause the one or more processors to generate the one or more signals at least by:
generating a first plurality of signals that include the first signal, wherein each signal in the first plurality of signals
spans the first frequency band, and
corresponds to a respective transmit antenna; and
generating a second plurality of signals that include the second signal, wherein each signal in the second plurality of signals
spans the second frequency band, and
corresponds to a respective transmit antenna.

16-25. (canceled)
